(19) United States
(12) Patent Application Publication
(10) Pub. No.: US 2026/0208730 A1
(43) Pub. Date: Jul. 23, 2026

(54) VEHICLE MOTION RATE LIMITS

(71) Applicant: Ford Global Technologies, LLC, Dearborn, MI (US)

(72) Inventor: Brandon Jay Woodland, Livonia, MI (US)

(73) Assignee: Ford Global Technologies, LLC, Dearborn, MI (US)

(21) Appl. No.: 19/026,888

(22) Filed: Jan. 17, 2025

(51) Int. Cl. B60W 30/14; B60W 30/02

(52) U.S. Cl. CPC B60W 30/143; B60W 30/025; B60W 2520/30; B60W 2554/802

(57) ABSTRACT

While a vehicle is moving with negative wheel torque, a first motion rate limit is applied upon detecting an input to positively accelerate the vehicle. Upon detecting, after responding to the input to positively accelerate the vehicle according to the first motion rate limit, that the vehicle has achieved a neutral acceleration state, a second motion rate limit is applied to cause positive wheel torque for acceleration of the vehicle. The first motion rate limit applied during the negative wheel torque is greater than the second motion rate limit that is applied during the positive wheel torque.

### BACKGROUND

Vehicle speed can affect occupant comfort. For example, a rate of change of vehicle speed (i.e., acceleration, the first derivative of speed) and/or a rate of change of the rate of change of vehicle speed (i.e., jerk, the second derivative of speed), can affect occupant comfort. When a vehicle propulsion system receives a command to change a vehicle speed, acceleration and/or jerk can result and may cause occupant discomfort. Vehicle speed can be changed according to user input and/or commands from a vehicle computer such as a computer implementing an adaptive cruise control, automated speed control, or the like. User input to increase or decrease vehicle speed may be provided via one or more foot pedals such as conventional side-by-side brake and accelerator pedals. Alternatively, user input for both increasing and decreasing vehicle speed may be provided via a single pedal in what may be referred to as a one-pedal driving mode.

### BRIEF DESCRIPTION OF THE DRAWINGS

FIG. 1 is a diagram of an example vehicle system.

FIG. 2 illustrates example graphs of a vehicle speed change scenario.

FIG. 3 is a diagram of an example process for operating a vehicle according to motion rate limits.

### DESCRIPTION

### Introduction

Described herein are systems and methods for controlling acceleration in a vehicle, encompassing control of both positive acceleration and negative acceleration. A vehicle computer can be commanded to actuate positive acceleration and/or to actuate negative acceleration (also referred to as deceleration). The computer can implement motion rate limits (such as acceleration rate limits or wheel torque change rate limits) for positive and/or negative acceleration scenarios to enhance the operation of the vehicle. For example, when the vehicle transitions from a negative acceleration to a positive acceleration, occupants may experience discomfort. Controlling acceleration as described herein, including according to motion rate limits that are calibrated, for example, to enhance occupant comfort, can provide enhanced vehicle operation.

The vehicle computer can detect input to decrease a speed of a vehicle, such as a user lifting a foot or otherwise providing input to a control pedal in a one-pedal driving mode. In other words, the user may provide input in the one-pedal driving mode to brake or slow the vehicle. When the input to brake or slow the vehicle is provided when the vehicle is undergoing positive acceleration, braking the vehicle will result in a transition from positive acceleration to negative acceleration. This transition can cause discomfort to a vehicle occupant. Further, when input is provided, during negative acceleration of the vehicle, to accelerate the vehicle, an occupant may experience discomfort.

The vehicle computer can be programmed to apply a first motion rate limit when a vehicle is moving with negative acceleration and input is received for positive acceleration. The first motion rate limit can allow the vehicle to reduce its deceleration at a rate that is calibrated to avoid disturbance to occupant comfort and that allows a positive rate of change of acceleration while the vehicle is decelerating (i.e., while acceleration is negative) greater than the positive rate of change of acceleration that would be appropriate for occupant comfort if the vehicle is positively accelerating. When the vehicle crosses a neutral acceleration state in which acceleration is zero, i.e., the vehicle is transitioning from negative to positive acceleration, a second motion rate limit can be applied for the positive acceleration. The second motion rate limit is lower, that is, allows for lower positive acceleration when the vehicle is positively accelerating compared to the higher first motion rate limit provided when the vehicle is still decelerating.

A system as described herein comprises a processor and a memory, the memory storing instructions executable by the processor to control a speed of a vehicle, including instructions to, while the vehicle is moving with negative wheel torque, apply a first motion rate limit upon detecting an input to positively accelerate the vehicle. Upon detecting, after responding to the input to positively accelerate the vehicle according to the first motion rate limit, that the vehicle has achieved a neutral acceleration state, apply a second motion rate limit to cause positive wheel torque for acceleration of the vehicle. The first motion rate limit applied during the negative wheel torque is greater than the second motion rate limit that is applied during the positive wheel torque.

In examples of the system, the input can be a user input. The user input can be provided while the vehicle is in a one-pedal mode. The motion rate limit can include a wheel torque rate change limit or an acceleration rate change limit. The neutral acceleration state can be defined by a continuous range of wheel torque that includes zero wheel torque. The neutral acceleration state can be defined by a continuous range of vehicle acceleration that includes zero acceleration. The first motion rate limit and the second motion rate limit can be selected from a lookup table. Values in the lookup table, including the first motion rate limit and the second motion rate limit, can be populated from empirical testing. The first motion rate limit can be selected from a first lookup table and the second motion rate limit can be selected from a second lookup table. The first motion rate limit and the second motion rate limit can be based on user input. The first motion rate limit and the second motion rate limit can be based on a distance to a forward vehicle defined for an adaptive cruise control in the vehicle. The first motion rate limit and the second motion rate limit can be based on a trajectory of an object detected by data from a vehicle sensor.

A method comprises, while a vehicle is moving with negative wheel torque, a first motion rate limit is applied upon detecting an input to positively accelerate the vehicle. Upon detecting, after responding to the input to positively accelerate the vehicle according to the first motion rate limit, that the vehicle has achieved a neutral acceleration state, a second motion rate limit is applied to cause positive wheel torque for acceleration of the vehicle. The first motion rate limit that is applied during the negative wheel torque is greater than the second motion rate limit that is applied during the positive wheel torque.

In examples of the method, the input can be a user input. The user input can be provided while the vehicle is in a one-pedal mode. The motion rate limit can include a wheel torque rate change limit or an acceleration rate change limit. The neutral acceleration state can be defined by a continuous range of wheel torque that includes zero wheel torque. The neutral acceleration state can be defined by a continuous range of wheel torque that includes zero wheel torque and/or a continuous range of vehicle acceleration that includes zero acceleration The first motion rate limit and the second motion rate limit can be selected from a lookup table. Values in the lookup table, including the first motion rate limit and the second motion rate limit, can be populated from empirical testing. The first motion rate limit can be selected from a first lookup table and the second motion rate limit can be selected from a second lookup table. The first motion rate limit and the second motion rate limit can be based on user input. The first motion rate limit and the second motion rate limit can be based on a distance to a forward vehicle defined for an adaptive cruise control in the vehicle. The first motion rate limit and the second motion rate limit can be based on a trajectory of an object detected by data from a vehicle sensor.

### Example Vehicle System

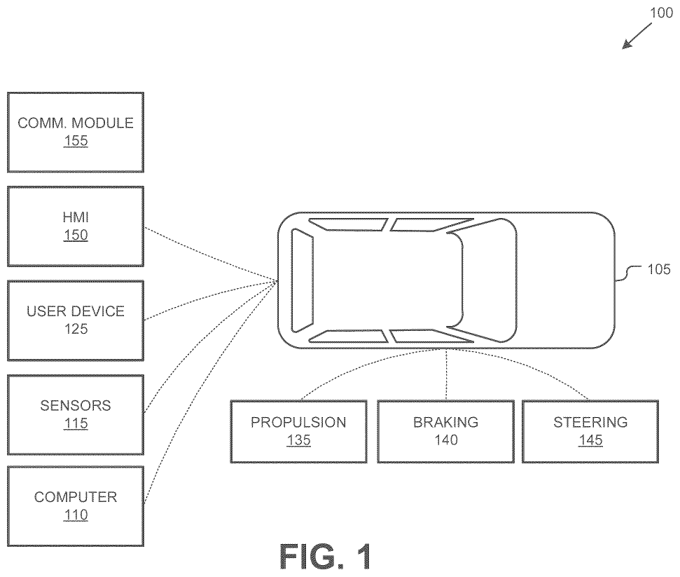

FIG. 1 illustrates an example system 100 for a vehicle 105. A computer 110 in the vehicle 105 is programmed to receive data collected from one or more sensors 115, and other sensors (not shown), to provide certain vehicle data. For example, one or more camera sensors 115 may provide image data from a camera's field of view. A user device with a touch screen may be disposed in vehicle 105. Example user devices include a vehicle computer 110 communicatively coupled (e.g., via a vehicle network) to an HMI 150 with a touch screen installed as part of a vehicle 105 infotainment system, or a hand-held portable computing device 125 with a touch screen. While all modern original equipment manufacturers (OEMs) of passenger vehicles currently warn drivers against using a hand held portable device while driving a vehicle due to safety concerns, it is anticipated that technology and the regulatory framework may evolve in the future to where such an activity becomes safe and permissible.

Vehicle data may further include a location of the vehicle 105, data about an environment around a vehicle, data about an object outside the vehicle such as another vehicle, etc. A vehicle location may be provided in a conventional form, e.g., geo-coordinates such as latitude and longitude coordinates obtained via a navigation system that uses a global navigation satellite system (GNSS) such as the Global Positioning System (GPS) system. Further examples of vehicle data can include measurements of vehicle systems and components, e.g., a vehicle speed or velocity, a level of fuel in a fuel tank, etc.

A computer 110 can be provided to control one or more vehicle operations including steering, acceleration or speed control, and/or braking. Accordingly, system 100 is shown comprising vehicle 105 which may include Driver Assistance System (DAS) features. A computer 110 (e.g., one or more vehicle 105 electronic control units, i.e., ECUs) can be configured to operate the vehicle 105 independently of operation by an occupant with regard to certain features. A computer 110 may be programmed to provide a driver assistance system (DAS) such as cruise control (where the computer maintains vehicle speed according to a set speed), adaptive cruise control (ACC) (where the computer maintains the vehicle speed according to a set speed but can adjust vehicle speed based on detected distances and/or speeds of other vehicles), and/or hands-free driving. For example, the computer 110 could provide hand-free driving in combination with ACC such that the computer 110 controls steering, braking and acceleration. In another example, the computer 110 could provide ACC and require hands-on operation. The computer 110 may be programmed to operate a propulsion system 135, a braking system 140, a steering system 145, a device screen that displays a Human Machine Interface (HMI) 150, and/or other vehicle systems.

A computer 110 is generally programmed for communications on a vehicle network (not shown), for example, a conventional vehicle communications bus such as a Controller Area Network (CAN) bus, a Local Interconnect Network (LIN) bus, etc., and/or other wired and/or wireless technologies, e.g., Bluetooth®, Wi-Fi®, Ethernet, etc. via the network, bus, and/or other wired or wireless mechanisms (e.g., a wired or wireless local area network in the vehicle 105), the computer 110 may transmit messages to various devices in the vehicle 105 and/or receive messages from the various devices, e.g., sensors 115, controllers and actuators (not shown), etc.

Alternatively or additionally, for example, in cases where the computer 110 actually comprises multiple devices, the vehicle network may be used for communications between devices represented as the computer 110 in this disclosure. For example, the computer 110 can be a generic computer with a processor and memory as described above, and/or may include a dedicated electronic circuit including an application specific integrated circuit (ASIC) that is manufactured for a particular operation, e.g., an ASIC for processing sensor data and/or communicating the sensor data. In another example, the computer 110 may include a Field-Programmable Gate Array (FPGA), which is an integrated circuit manufactured to be configurable by a user. Typically, a hardware description language such as Very high speed integrated circuit Hardware Description Language (VHDL) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g. stored in a memory electrically connected to the FPGA circuit. In some examples, a combination of processor(s), ASIC(s), and/or FPGA circuits may be included in computer 110.

In addition, the computer 110 may be programmed for communicating with a network and/or devices outside of the vehicle (not shown), which may include various wired and/or wireless networking technologies, e.g., cellular, Bluetooth®, Bluetooth® Low Energy (BLE), wired and/or wireless packet networks, etc.

The memory can be of any type, e.g., hard disk drives, solid state drives, servers, or any volatile or non-volatile media. The memory can store the collected data sent from the sensors 115. The memory can be a separate device from the computer 110, and the computer 110 can retrieve data stored in the memory via a network in the vehicle 105, e.g., over a CAN bus, a wireless network, etc. Alternatively or additionally, the memory can be part of the computer 110, e.g., as a memory of the computer 110.

Sensors 115 can include a variety of devices. For example, various controllers in a vehicle 105 may operate as sensors 115 to provide data via the vehicle network or bus, e.g., data relating to vehicle speed, acceleration, location, subsystem and/or component status, etc. Further, other sensors 115 could include cameras, motion detectors, etc., i.e., sensors 115 may provide data for evaluating a status of a component, evaluating a slope of a roadway, etc. The sensors 115 could, without limitation, also include short range radar, long range radar, light detection and ranging (LIDAR), ultrasonic transducers, and the like. Cameras herein typically are optical cameras, e.g., in the visible spectrum, but could alternatively or additionally include other kinds of cameras, e.g., time-of-flight, infrared, etc.

Collected data can include a variety of data collected in a vehicle 105. Examples of collected data are provided above. Data are generally collected using one or more sensors 115, and may additionally include data calculated therefrom in the computer 110. In general, collected data may include any data gathered by the sensors 115 and/or computed from such data.

The vehicle 105 can include a plurality of vehicle components. In this context, a vehicle component may include one or more hardware components adapted to perform a mechanical function or operation-such as moving the vehicle 105, slowing or stopping the vehicle 105, steering the vehicle 105, etc. Non-limiting examples of components include a propulsion component 135 (that includes, e.g., an internal combustion engine and/or electric motor, etc.), a transmission component, a steering assembly (e.g., that may include one or more of a steering wheel, a steering rack, etc.), a brake component 140, a park assist component, an adaptive cruise control component, an adaptive steering component 145, a movable seat, and the like. Components can include computing devices, e.g., electronic control units (ECUs) or the like and/or computing devices such as described above with respect to the computer 110, and that likewise communicate via a vehicle network.

The HMI 150 typically includes one or more of a display, a touchscreen display, a microphone, a speaker, etc. The user can provide input to devices such as the computer 110 via the HMI 150. The HMI 150 can communicate with the computer 110 via the vehicle network, e.g., the HMI 150 can send a message including the user input provided via a touchscreen, microphone, a camera that captures a gesture, etc., to a computer 110, and/or can display output, e.g., via a screen, speaker, etc.

In addition, the vehicle computer 110 may be configured for communicating via a vehicle-to-vehicle communication module 155 or interface with devices outside of the vehicle 105 (e.g., through a vehicle-to-vehicle (V2V) or vehicle-to-infrastructure (V2X) wireless communications (cellular and/or short-range radio communications, etc.) to another vehicle, and/or to a remote server computer (typically via direct radio frequency communications)). The communications module 155 could include one or more mechanisms, such as a transceiver, by which the computers of vehicles may communicate, including any desired combination of wireless (e.g., cellular, wireless, satellite, microwave and radio frequency) communication mechanisms and any desired network topology (or topologies when a plurality of communication mechanisms are utilized). Exemplary communications provided via the communications module 155 include cellular, Bluetooth, IEEE 802.11, dedicated short range communications (DSRC), cellular V2X (CV2X), and/or wide area networks (WAN), including the Internet, providing data communication services. The label “V2X” is used herein for communications that may be vehicle-to-vehicle (V2V) and/or vehicle-to-infrastructure (V2I), and that may be provided by communication module 155 according to any suitable short-range communications mechanism (e.g., DSRC, cellular, or the like).

### Example Implementation

The computer 110 memory can include instructions executable by the computer 110 processor to control a speed of the vehicle 105, including controlling vehicle speed and acceleration. As used herein, “speed” has the conventional meaning of a rate at which an object such as a vehicle changes location with respect to a travel surface or medium, such as the ground or a road in the case of a vehicle. For example, speed can be measured in kilometers per hour (kph), meters per second (m/s), etc. “Acceleration” likewise has the conventional meaning of a rate of change of speed, and is determined as a first derivative of speed. For example, acceleration can be measured as meters per second squared (m/s²), etc. Acceleration can be positive, indicating a rate of increase of speed, or negative, indicating a rate of decrease of speed (negative acceleration may also be referred to as “deceleration”). Moreover, “jerk” is the first derivative of acceleration and the second derivative of speed, and thus provides a rate of change of acceleration.

Linear acceleration of a vehicle is directly proportional to wheel torque; therefore, a command for acceleration of the vehicle can be translated or interpreted as a command for a wheel torque. Moreover, a rate of change of wheel torque (torque is a twisting force or moment that can be measured in newton-meters, for example) can be translated or interpreted as jerk. Accordingly, motion rate limits herein may be expressed as acceleration rate limits or wheel torque rate limits. That is, jerk, the derivative of acceleration, can be translated to the derivative of wheel torque. Linear acceleration and wheel torque may generally be used interchangeably because of their proportional relationship. However, there are examples in which acceleration could be positive or increasing even when wheel torque is negative or decreasing, such as when a vehicle 102 is traveling downhill (i.e., on a downgrade) and speed is constant or increasing even though the vehicle is implementing a braking or drag action to reduce wheel torque. This is because gravity imparts another acceleration component on the vehicle.

The vehicle computer 110 can detect a command to increase and/or decrease a speed of the vehicle 105. In one contemplated implementation, a vehicle operator may provide input via a foot pedal in a one-pedal driving mode to increase or decrease the vehicle 105 speed. A one-pedal driving mode means that the vehicle 105 is configured for vehicle 105 speed to be controlled via a single vehicle foot pedal (rather than via separate brake and accelerator pedals, for example). In the one-pedal driving mode, typically the operator pressing or depressing the pedal is interpreted as a command to increase the vehicle 105 speed, and releasing or lifting the pedal is interpreted as a command to decrease the vehicle 105 speed. The computer 110 can be programmed to interpret various amounts or distances by which the pedal is pressed or released as commands to increase or decrease vehicle 105 speed by respective amounts.

The computer 110 can command the increase and/or decrease in vehicle 105 speed according to a motion rate limit, which in examples herein can be an acceleration rate limit or a wheel torque change rate limit. An “acceleration rate limit” means a limitation or threshold acceleration value that is used to limit acceleration in a vehicle. A “wheel torque change rate limit” means a limitation or threshold wheel torque value that is used to limit acceleration in a vehicle. As explained above, due to the relationship between acceleration and wheel torque, an acceleration rate limit could also be expressed as a wheel torque rate limit. In any case, a motion rate limit can be positive or negative. A positive rate limit applies to acceleration that is increasing, which could be a negative acceleration moving to a less negative acceleration (“less negative” being used here in the sense that −2 is greater than, and therefore “less negative” than −3). Further, acceleration could be increasing from a negative acceleration to a positive acceleration, or could be a smaller positive acceleration increasing to a greater positive acceleration. Similarly, a negative rate limit applies to acceleration that is decreasing, that is, to deceleration. The negative rate limit could therefore apply to a greater positive acceleration decreasing to a lesser positive acceleration or a negative acceleration, or to a less negative acceleration decreasing to a more negative acceleration. Similar principles apply to wheel torque values.

As just mentioned, the vehicle computer 110 can receive respective commands to change (i.e., increase and/or decrease) vehicle speed over time. For example, the vehicle 105 may be undergoing a negative acceleration, whereupon the vehicle computer 110 receives a first command to increase the speed of (i.e., positively accelerate) the vehicle 105. Upon detecting the first command to increase the speed of the vehicle 105 while the vehicle is operating according to a negative acceleration, the computer 110 can then operate the vehicle 105 according to a negative acceleration that does not exceed a first motion rate limit. Then, upon detecting, during the negative acceleration of the vehicle not exceeding the first motion rate limit, that the vehicle has achieved a neutral acceleration state, and therefore is transitioning to positive acceleration, the computer 110 can apply a positive acceleration to the vehicle according to a second motion rate limit that is less than the first motion rate limit. A “neutral acceleration state” means zero acceleration or an acceleration within a predetermined range of zero acceleration, and/or that wheel torque is zero or within a predetermined range of zero. Note that, in this example, both the first motion rate limit and the second motion rate limit are positive rate limits.

Motion rate limits can be determined by empirical testing and/or simulation, and/or by design considerations such as a desired stopping distances for the vehicle 105 at respective speeds, a desired time to accelerate from a first speed to a second speed, etc. The empirical testing and/or simulation can include monitoring occupant comfort, for example, having occupants provide feedback concerning their comfort, under various acceleration scenarios while a test vehicle is driven on a road, test track, etc. Accelerations or acceleration rates associated with respective levels of occupant comfort could be then recorded and used to determine motion rate limits as described and used herein. Further, empirical testing could be performed for a particular type, e.g., make and model, of vehicle 105 because occupants could have different comfort levels with respective accelerations in different types of vehicles.

Motion rate limits can thereby be used to provide acceleration in a vehicle 105 that is calibrated for occupant comfort, for example. That is, motion rate limits herein are typically selected based on the observation that occupants experience less discomfort at higher positive motion rate limits when a vehicle is decelerating (i.e., when acceleration is negative) than when a vehicle is accelerating (i.e., when acceleration is positive). Stated another way, occupants tend to experience less discomfort when acceleration is moving towards zero quickly than when it is moving away from zero quickly. In some situations, such as where a vehicle 105 is in a one-pedal driving mode, response delay caused by the slow rate of wheel torque or acceleration delivery can be difficult to predict. For example, in a one-pedal mode, when the driver's foot is off the pedal, and the vehicle 105 deceleration is high (wheel torque has a large negative value), a request to accelerate the vehicle 105, if delivered at a slow rate for occupant comfort could delay acceleration of the vehicle 105 after the request is received. This is because the slow torque delivery rate causes negative torque (or deceleration) to remain in effect for some time until it can be transitioned across zero and into the positive torque (or positive acceleration) range. This can provide challenges in controlling a vehicle 105 at a slow wheel torque rate or acceleration rate. Techniques herein can address such situations where the vehicle 105 may otherwise be too slow to respond to a request to change the vehicle acceleration, for example, addressing difficulties for a human driver or a computer controller to adapt the vehicle acceleration to traffic or road conditions.

Yet further, the first motion rate limit and/or the second motion rate limit could be based on user input in a vehicle 105. For example, motion rate limits could be stored in a memory of the computer 110, such as illustrated below in Tables 1 and 2, and then a vehicle user could be provided the opportunity to provide input via a vehicle HMI 150 customizing one or more motion rate limits for the user. For example, the user may find a relatively high motion rate more comfortable than typical users. Accordingly, the user could be provided the opportunity, e.g., via a knob or slider control or the like in the HMI 150, to specify that the user desires higher motion rate limits, wherein a motion rate limit for the user could be adjusted upward, subject to an ultimate or an adjustable motion rate limit that may be stored for the vehicle 105 for a given speed. Similarly, the user could be provided the opportunity via the HMI 152 to specify that the user desires lower motion rate limits. For example, the knob or slider control could allow the user to specify adjustments to motion rate limits within a range such as plus or −5% or 10%, etc.

Motion rate limits could be stored in, and selected by the computer 110 from, a lookup table or the like in a memory of the computer 110. For example, a lookup table could provide motion rate limits that could be used by the computer 110 when a command is received to decelerate the vehicle 105 while the vehicle 105 is being operated with a positive acceleration. The lookup table could further provide motion rate limits that could be used by the computer 110 when a command is received to accelerate the vehicle 105 while the vehicle 105 is being operated with a negative acceleration.

Tables 1 and 2 below illustrate motion rate limits that could be stored in a lookup table or the like in the computer 110. Table 1 provides motion rate limits as wheel torque rate change limits (in units of newton-meters per second) for pairs of vehicle speed (speed labels are in the top row of Table 1, and refer to speeds in kilometers per hour) and vehicle wheel torque values (labeled in the leftmost column of Table 1 referring to torque values in newton-meters). Table 2 provides motion rate limits as wheel torque rate change limits (in units of newton-meters per second) for pairs of vehicle speed (in KPH) and acceleration input values, which are labeled in the leftmost column of Table 2 and referring to a percentage that a foot pedal is depressed from user input, starting with one percent in the top row and going to one hundred percent in the bottom row. These percentages can be translated to torque commands, as explained above.

Tables 1 and 2 provide motion rate limits for vehicle speeds ranging from −3 KPH to 144 KPH. This range of speeds is merely exemplary and different and/or additional speeds could be indicated in the lookup tables. For example, the tables begin at −3 KPH to accommodate a situation in which a vehicle 102 is traveling in reverse, and could be shifted to travel forward. This scenario could occur when a vehicle 102 is maneuvering out of a garage, driveway, or parking place, for example. Further, some implementations include motion rate limits for even greater negative speeds, although examples are rare in which a vehicle is traveling at greater negative speeds, such as −30 KPH or −40 KPH, much less then transitioned to positive forward acceleration.

In an example implementation, vehicle computer 110 determines a current wheel torque value and a current acceleration input value to find applicable motion rate change limits (i.e., a wheel torque rate change limit in the example implementation) from the respective tables, and then applies a MAX function to select an applicable motion rate change limit, that is, the computer 110 takes the highest of the values indicated by Table 1 and Table 2. In the example implementation, Tables 1 and 2 are designed so that Table 2, in which wheel torque rate change limits are calibrated to acceleration input values (rather than wheel torque values as in Table 1), provides the applicable motion rate limit when acceleration input is positive. That is, it will be noted that for positive wheel torque values in Table 1, the specified motion rate limit is zero in every instance, meaning that the MAX function will result in selecting the motion rate limit from Table 2.

TABLE 1

| | Speed | | | | | | |
|---|---|---|---|---|---|---|---|
| Torque | −3.000 | 5.000 | 16.000 | 32.000 | 64.000 | 128.000 | 144.000 |
| −2000.000 | 25000.000 | 25000.000 | 25000.000 | 25000.000 | 25000.000 | 25000.000 | 25000.000 |
| −1500.000 | 10000.000 | 10000.000 | 10000.000 | 10000.000 | 10000.000 | 10000.000 | 10000.000 |
| −1000.000 | 7000.000 | 7000.000 | 7000.000 | 7000.000 | 7000.000 | 7000.000 | 7000.000 |
| −500.000 | 5000.000 | 5000.000 | 5000.000 | 5000.000 | 5000.000 | 5000.000 | 5000.000 |
| −250.000 | 700.000 | 700.000 | 700.000 | 700.000 | 700.000 | 700.000 | 700.000 |
| 0.000 | 700.000 | 700.000 | 700.000 | 700.000 | 700.000 | 700.000 | 700.000 |
| 1000.000 | 0.000 | 0.000 | 0.000 | 0.000 | 0.000 | 0.000 | 0.000 |
| 2000.000 | 0.000 | 0.000 | 0.000 | 0.000 | 0.000 | 0.000 | 0.000 |
| 5000.000 | 0.000 | 0.000 | 0.000 | 0.000 | 0.000 | 0.000 | 0.000 |

TABLE 2

| | Speed | | | | | | |
|---|---|---|---|---|---|---|---|
| Cmd | −3.000 | 5.000 | 16.000 | 32.000 | 64.000 | 128.000 | 144.000 |
| 1.000 | 700.000 | 700.000 | 700.000 | 700.000 | 700.000 | 700.000 | 700.000 |
| 2.000 | 800.000 | 800.000 | 800.000 | 800.000 | 800.000 | 800.000 | 800.000 |
| 12.000 | 800.000 | 800.000 | 800.000 | 800.000 | 800.000 | 800.000 | 800.000 |
| 23.000 | 1250.000 | 1250.000 | 1250.000 | 1250.000 | 1250.000 | 1250.000 | 1250.000 |
| 36.000 | 2800.000 | 2800.000 | 2800.000 | 2800.000 | 2800.000 | 2800.000 | 2800.000 |
| 48.000 | 5200.000 | 5000.000 | 5000.000 | 5000.000 | 5000.000 | 5000.000 | 5000.000 |
| 62.000 | 7000.000 | 7000.000 | 7000.000 | 7000.000 | 7000.000 | 7000.000 | 7000.000 |
| 98.000 | 9000.000 | 9000.000 | 9000.000 | 9000.000 | 9000.000 | 9000.000 | 9000.000 |
| 100.000 | 9000.000 | 9000.000 | 9000.000 | 9000.000 | 9000.000 | 9000.000 | 9000.000 |

Various inputs may provide a basis for commands to the computer 110 to accelerate or decelerate the vehicle 105. In one implementation, vehicle 105 is in a one-pedal driving mode and the commands are received according to user input, for example, the user depressing the pedal to cause acceleration of the vehicle 105 or lifting the pedal to cause deceleration or braking of the vehicle 105. Alternatively or additionally, commands to accelerate or decelerate a vehicle 105 could be provided from an adaptive cruise control system or other automated speed control system in a vehicle 105. Moreover, the first motion rate limit and the second motion rate limit could be adjusted based on a distance to a forward vehicle defined for an adaptive cruise control, that is, to allow the vehicle 105 to maintain the defined distance from the forward vehicle. Further, the first motion rate limit and the second motion rate limit could be adjusted based on a trajectory of an object detected by data from a vehicle sensor.

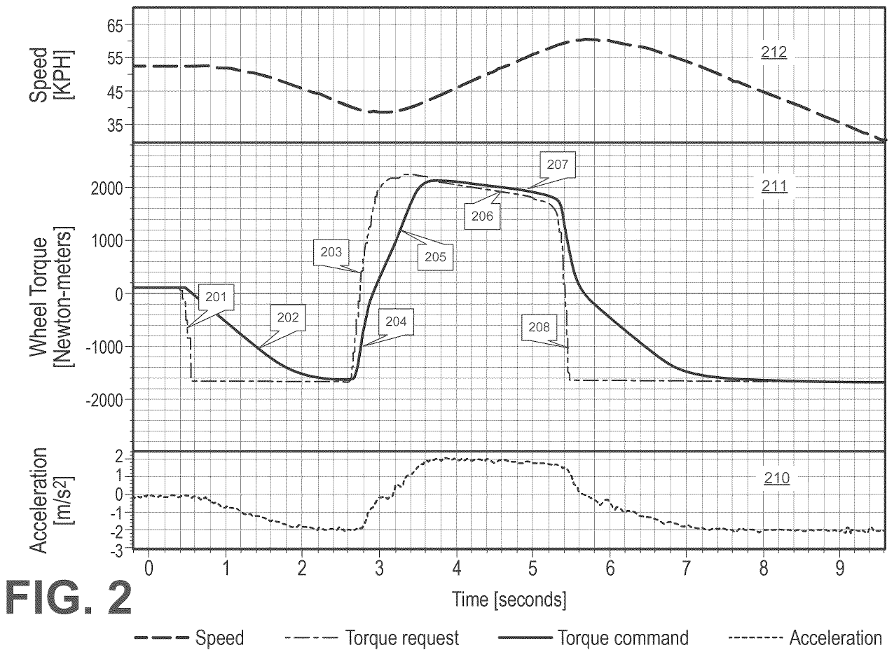

FIG. 2 illustrates example graphs of a vehicle speed change scenario. The underlying data for the graphs of FIG. 2, including the applicable motion rate limits, are provided in the Appendix. For ease of illustration, three graphs 210, 211, 212 are stacked one on top of each other with a common x-axis, whose units are time in seconds. The bottom graph is an acceleration graph 210 that plots vehicle acceleration over time in meters per second squared (m/s²). The middle graph is a torque graph 211 that plots wheel torque over time in Newton-meters, which accordingly are the units represented on the y-axis of the graph 211. The top graph is a speed graph 212 that plots vehicle speed over time in kilometers per hour (KPH), which accordingly are the units represented on the y-axis of the graph 212.

Various portions 201-207 of plots included in the torque graph 211 are labeled in FIG. 2; it is to be understood that these portions likewise could be labeled for portions of the acceleration graph 210 and speed graph 212 corresponding to the same periods of time as indicated by the units of time marked on the common x-axis of the graphs 210, 211, 212. The plots begin at a time arbitrarily labeled 0, that is, vehicle 105 operation (or simulation of a vehicle 105 operating) could have been performed prior to time 0, but for convenience, the scenario described herein begins at time 0.

The torque graph 211 includes a plot of a torque request (e.g., as translated from a user input to a pedal when operating a vehicle in one-pedal mode), and a torque command (i.e., commanded wheel torque based on the torque request as well as other considerations including one or more motion rate limits). A first portion 201 of the torque request plot in the graph 211 illustrates a torque request to implement negative wheel torque, that is, to decelerate a vehicle 105, the torque request being received in the time from 0.4 to 0.6 seconds. Prior to time 0.4 seconds, the vehicle 105 was in a neutral state, cruising at a speed of between 50 and 55 KPH, with the wheel torque request and command being zero or only what is necessary to overcome aerodynamic and mechanical losses to maintain constant speed of the vehicle. When the torque request to implement negative wheel torque (i.e., decelerate the vehicle 105) is received, in a portion 202 of the plot of the torque command in the graph 211, the torque command is reduced over time (beginning at 0.4 seconds and until about 2.6 seconds). That is, the vehicle 105 decelerates.

Then, at about 2.6 seconds, while the vehicle 105 is decelerating, as shown in a portion 203 of the plot of the torque request, a positive torque request, that is, user input to accelerate the vehicle 105, is received. For example, a user having lifted a foot from a pedal in a one-pedal mode (which is the request to implement negative torque or decelerate) may have then depressed the pedal (which is the request for positive torque, that is, to accelerate). Accordingly, in a portion 203 of the graph 211, beginning at about 2.6 seconds, as the torque request increases correspondingly, in a portion 204 of the plot of the torque command, the commanded torque increases. In the portion 204 the increased torque command is according to a first rate limit such as described above. Further, as seen in the portion 205 of the torque command plot which is contiguous with the portion 204, the torque command continues to increase after the portion 204, but at a second rate limit less than the first rate limit. Moreover, the transition from the portion 204 to the portion 205 is when the vehicle 105 acceleration is in a neutral state, that is, when the wheel torque is transitioning from negative to positive and has a 0 value. As can be seen in FIG. 2 the portion 204 has a steeper slope than the portion 205. This is because the positive acceleration limit applied to the deceleration that is occurring in the portion 204 is greater than the positive acceleration rate limit applied to the acceleration that is occurring in the portion 205.

### Example Process

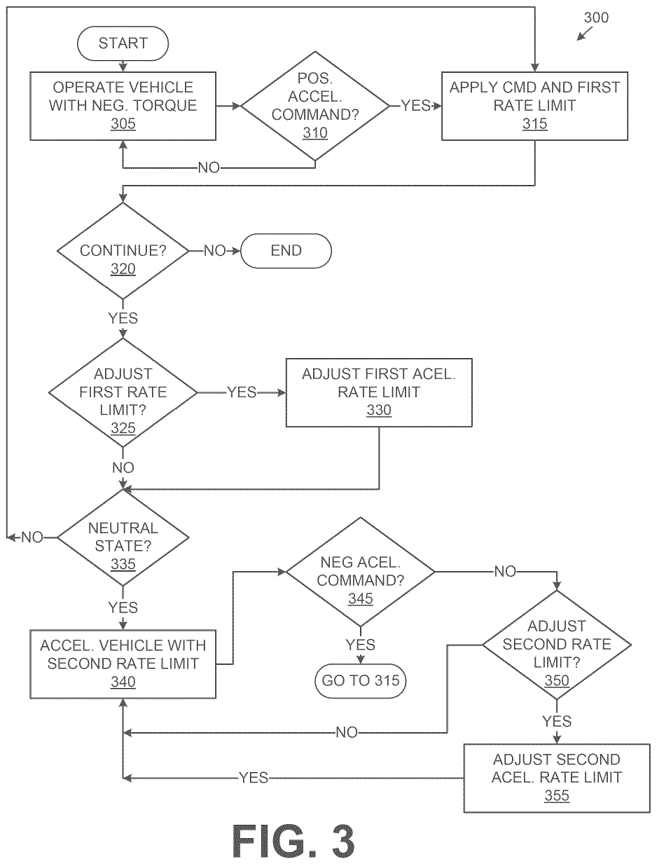

FIG. 3 is a diagram of an example process 300 for operating a vehicle 105 according to motion rate limits. Various blocks or steps of the process 300 may be carried out according to program instructions in a computer 110 in a vehicle 105.

The process 300 begins in a block 305, in which a vehicle 105 is operated on a travel surface such as a road, street, highway, etc., and is experiencing negative wheel torque, which typically means that the vehicle is negatively accelerating, that is, is decelerating or decreasing speed. However, as discussed above, scenarios are possible in which a vehicle is experiencing negative wheel torque, such as when traveling downhill, but not decelerating.

In a decision block 310, following the block 305, the computer 110 determines whether a command has been received to positively accelerate the vehicle 105, while the vehicle 105 is being operated with negative acceleration. For example, a user in one-pedal driving mode could have depressed the pedal to indicate a desire to increase vehicle 105 speed. If not, the process 300 returns to the block 305. If a positive acceleration command is received, the process 300 proceeds to the block 315.

In the block 315, the computer 110 applies the positive acceleration command according to a first motion rate limit. For example, the computer 110 could increase wheel torque from a negative value to a less negative value according to a wheel torque rate change limit. Typically, in applying the positive acceleration command while the vehicle is decelerating, the computer 110 causes the vehicle 105 to continue to decelerate, that is, decrease speed. However, the magnitude of the deceleration decreases at a rate not exceed the first rate limit. For example, the computer 110 could provide the command according to the first rate limit to a propulsion controller or brake controller or the like. As explained above, the computer 110 can select the first motion rate limit by consulting one or more lookup tables or the like.

Following the block 315, in a block 320, the computer 110 determines whether to continue the process 300. For example, if a negative acceleration command is received after the positive acceleration command of the block 310, or if the vehicle 105 decelerates to a stop, then the process 300 ends following the block 320. However, if an end condition is not reached, then the process 300 proceeds to a block 325.

In the block 325, the computer 110 determines whether to adjust the first motion rate limit. As explained above, a first motion rate limit can be dependent on factors including, for example, a vehicle 105 speed, acceleration inputs that are commanded, or wheel torque. Accordingly, as the vehicle slows and its speed changes, the computer 110 may determine, for example based on a lookup table or tables, that the first motion rate limit (limiting the rate at which negative acceleration or wheel torque becomes less negative or approaches a value near zero) should be adjusted based on the speed change and/or a change in wheel torque. If an adjusted first motion rate limit is warranted, the process 300 proceeds to the block 330. Otherwise, the process 300 proceeds to the block 335.

In the block 330, the computer 110 adjusts the first motion rate limit, for example, as specified in a lookup table or tables or the like. The process 300 then returns to the block 315.

In the decision block 335, which may follow the block 325 or the block 330, the computer 110 determines whether the vehicle 105 has achieved a neutral state, which as explained above may be defined as a state in which the vehicle is experiencing zero acceleration and/or wheel torque. Alternatively or additionally, the neutral acceleration state can encompass a range of acceleration or wheel torque values from less than zero to greater than zero. If the vehicle 105 has achieved the neutral state, then the process 300 proceeds to a block 340. Otherwise, the process 300 returns to the block 315.

In the block 340, the vehicle 102, having transitioned from negative acceleration to positive acceleration, the computer 110 causes the vehicle 105 to accelerate, that is, increase speed, so as to not exceed a second rate limit during the positive acceleration. For example, the computer 110 could cause the vehicle to operate according to the positive acceleration by providing the command according to the second rate limit to a propulsion controller or brake controller or the like. As explained above, the computer 110 can select the second motion rate limit from a lookup table or tables or the like specifying the motion rate limit according to an accelerator pedal input command (or commanded wheel torque) and a current vehicle speed.

Following the block 345, in a decision block 350, the computer 110 determines whether a negative acceleration command has been received. For example, a vehicle 105 operator could lift or release a pedal while operating the vehicle 105 in one-pedal operating mode. If a negative acceleration command has been received (as shown in the portion 208 of FIG. 2), the computer 110 may follow any strategy to command a negative acceleration or negative wheel torque. If a positive acceleration command is received before the delivered torque or acceleration becomes negative, then the process 300 returns to the block 340 and applies the second motion rate limit to the command. Alternatively, if the delivered torque or acceleration becomes negative, then the process 300 returns to the block 305 and awaits a positive acceleration or a positive wheel torque command. Otherwise, a block 350 is executed next.

In the decision block 350, the computer 110 determines whether to adjust the second motion rate limit. As explained above, a second motion rate limit for limiting positive acceleration can be dependent on factors including a vehicle 105 speed. Accordingly, as the vehicle accelerates and its speed changes, the computer 110 may determine, for example based on a lookup table such as illustrated in Table 3, that the second motion rate limit (limiting the rate at which positive acceleration or wheel torque becomes more positive, moving away from a value near zero) should be adjusted based on the speed change. If an adjusted second motion rate limit is warranted, the process 300 proceeds to the block 355. Otherwise, the process 300 returns to the block 340.

In the block 355, the computer 110 adjusts the second motion rate limit, for example, as specified in a lookup table or the like based on a current vehicle 105 speed. The process 300 then proceeds to the block 345.

### CONCLUDING REMARKS

Systems and methods described herein may be modified and/or omitted depending on the context, situation, and applicable laws, rules, and regulations. Further, regardless of actions that may be taken by a vehicle such as a computer controlling a vehicle, users should use good judgement and common sense when operating the vehicle. Operations described herein should always be implemented and/or performed in accordance with the owner manual and safety guidelines.

The computing devices discussed herein, including computer 110, include processors and memories. The memories generally including instructions executable by one or more of the computing devices' processors, such as instructions disclosed in the foregoing, and instructions for carrying out blocks or steps of processes described above. Computer executable instructions may be compiled or interpreted from computer programs created using a variety of programming languages and/or technologies, including, without limitation, and either alone or in combination, Java™, C, C++, Visual Basic, Java Script, Python, Perl, HTML, etc. In general, a processor (e.g., a microprocessor) receives instructions, e.g., from a memory, a computer readable medium, etc., and executes these instructions, thereby causing one or more actions and/or processes to occur, including one or more of the processes described herein. Such instructions and other data may be stored and transmitted using a variety of computer readable media. A file in the computer 110 is generally a collection of data stored on a computer readable medium, such as a storage medium, a random access memory, etc.

A computer readable medium includes any medium that participates in providing data (e.g., instructions), which may be read by a computer. Such a medium may take many forms, including, but not limited to, non volatile media, volatile media, etc. Non volatile media include, for example, optical or magnetic disks and other persistent memory. Volatile media include dynamic random access memory (DRAM), which typically constitutes a main memory. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. For example, in the process 300, one or more of the steps could be omitted, or the steps could be executed in a different order than shown in FIG. 3. In other words, the descriptions of systems and/or processes herein are provided for the purpose of illustrating certain embodiments and should in no way be construed so as to limit the disclosed subject matter.

“Based on” means based at least in part on unless explicitly stated otherwise. Therefore, if A is “based on” B, this means that A could be entirely determined based on B, or could be determined based on B and some other factor or factors.

Accordingly, it is to be understood that the present disclosure, including the above description and the accompanying Figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non-provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

The article “a” modifying a noun should be understood as meaning one or more unless stated otherwise, or context requires otherwise. The phrase “based on” encompasses being partly or entirely based on.

1. A system, comprising a processor and a memory, the memory storing instructions executable by the processor to control a speed of a vehicle, including instructions to:
while the vehicle is moving with negative wheel torque, apply a first motion rate limit upon detecting an input to positively accelerate the vehicle;
upon detecting, after responding to the input to positively accelerate the vehicle according to the first motion rate limit, that the vehicle has achieved a neutral acceleration state, apply a second motion rate limit to cause positive wheel torque for acceleration of the vehicle;
wherein the first motion rate limit applied during the negative wheel torque is greater than the second motion rate limit that is applied during the positive wheel torque.

2. The system of claim 1, wherein the input is a user input.

3. The system of claim 2, wherein the user input is provided while the vehicle is in a one-pedal mode.

4. The system of claim 1, wherein the first motion rate limit includes a wheel torque rate change limit or an acceleration rate change limit.

5. The system of claim 1, wherein the neutral acceleration state is defined by a continuous range of wheel torque that includes zero wheel torque.

6. The system of claim 1, wherein the neutral acceleration state is defined by a continuous range of vehicle acceleration that includes zero acceleration.

7. The system of claim 1, wherein values in the lookup table, including the first motion rate limit and the second motion rate limit, are populated from empirical testing.

8. The system of claim 1, wherein the first motion rate limit is selected from a first lookup table and the second motion rate limit is selected from a second lookup table.

9. The system of claim 1, wherein the first motion rate limit and the second motion rate limit are based on user input.

10. The system of claim 1, wherein the first motion rate limit and the second motion rate limit are based on a distance to a forward vehicle defined for an adaptive cruise control in the vehicle.

11. The system of claim 1, wherein the first motion rate limit and the second motion rate limit are based on a trajectory of an object detected by data from a vehicle sensor.

12. A method, comprising:
while a vehicle is moving with negative wheel torque, applying a first motion rate limit upon detecting an input to positively accelerate the vehicle;
upon detecting, after responding to the input to positively accelerate the vehicle according to the first motion rate limit, that the vehicle has achieved a neutral acceleration state, applying a second motion rate limit to cause positive wheel torque for acceleration of the vehicle;
wherein the first motion rate limit applied during the negative wheel torque is greater than the second motion rate limit that is applied during the positive wheel torque.

13. The method of claim 13, wherein the input is a user input provided while the vehicle is in a one-pedal mode.

14. The method of claim 13, wherein the first motion rate limit includes a wheel torque rate change limit or an acceleration rate change limit.

15. The method of claim 13, wherein the neutral acceleration state is defined by a continuous range of wheel torque that includes zero wheel torque and/or a continuous range of vehicle acceleration that includes zero acceleration.

16. The method of claim 13, wherein values for the first motion rate limit and the second motion rate limit are determined from empirical testing.

17. The method of claim 13, wherein the first motion rate limit is selected from a first lookup table and the second motion rate limit is selected from a second lookup table.

18. The method of claim 13, wherein the first motion rate limit and the second motion rate limit are based on user input.

19. The method of claim 13, wherein the first motion rate limit and the second motion rate limit are based on a distance to a forward vehicle defined for an adaptive cruise control in the vehicle.

20. The method of claim 13, wherein the first motion rate limit and the second motion rate limit are based on a trajectory of an object detected by data from a vehicle sensor.
